(19) United States
(12) Patent Application Publication
(10) Pub. No.: US 2024/0075625 A1
(43) Pub. Date: Mar. 7, 2024

(54) ASSEMBLING APPARATUS, ASSEMBLING METHOD AND COMPUTER READABLE STORAGE MEDIUM

(71) Applicant: ABB Schweiz AG, Baden (CH)

(72) Inventor: Yichao Mao, Shanghai (CN)

(21) Appl. No.: 18/261,747

(22) PCT Filed: Jan. 22, 2021
(86) PCT No.: PCT/CN2021/073245

§ 371 Date: Jul. 17, 2023

(51) Int. Cl. B25J 9/16; B25J 11/00

(52) U.S. Cl. CPC B25J 9/1697; B25J 9/1664; B25J 11/005

(57) ABSTRACT

An assembling apparatus and a assembling method. The assembling apparatus includes an image sensor arranged above an assembling station and a first robot arranged near to the assembling station. The first robot is configured to hold a first portion of an object to be assembled onto a target object arranged on the assembling station. The assembling apparatus includes a second robot arranged near to the assembling station and configured to hold a second portion of the object spaced apart from the first portion. The assembling apparatus includes a controller configured to cause the image sensor to capture images and control the first robot to move the first portion and based on the captured images, cause the second robot to move the second portion such that the object is aligned with the target object.

### FIELD

Embodiments of the present disclosure generally relate to the field of object assembling, and in particular, to an apparatus and a method for assembling objects with robots.

### BACKGROUND

Automatic assembling by a robot is often used in a production line of a factory to automate operation and save manpower. In automatic assembling, a system with a robot, such as a multi jointed arm can be used, which can improve efficiency and quality in assembling objects. In case that the kinematic accuracy of the robot does not meet the requirements for assembling, an adjusting system or a feedback system may be used to adjust a movement of the robot to improve the assembling accuracy. However, when assembling an object of a large size, the rotation error of the robot will lead to a much bigger error at the most distant edge of the object. Therefore, in order to improve the assembling accuracy, the robot is required to have a higher accuracy or equipped with a more complicated adjusting/feedback system, which makes the system more expensive and the assembling inefficient.

Thus, improved solutions for assembling the objects are still needed.

### SUMMARY

In general, example embodiments of the present disclosure provide an assembling apparatus and an assembling method for assembling an object onto a target object.

In a first aspect, there is provided an assembling apparatus. The assembling apparatus comprises: an image sensor arranged above an assembling station; a first robot arranged near to the assembling station and configured to hold a first portion of an object to be assembled onto a target object arranged on the assembling station; a second robot arranged near to the assembling station and configured to hold a second portion of the object spaced apart from the first portion; and a controller configured to: cause the image sensor to capture images of the object and the target object; based on the captured images, cause the first robot to move the first portion by a first distance in a first direction; and based on the captured images, cause the second robot to move the second portion by a second distance different from the first distance in the first direction or move the second portion in a direction opposite to the first direction, such that the object is aligned with the target object.

With the above embodiments, the object, especially the object of large size, can be assembled by the cooperation of the robots without increasing the accuracy requirement of the individual robot. Moreover, the assembling accuracy is increased by the cooperation of the robots without need of a very complicated adjusting/feedback system.

In some embodiments, at least one of the first and second robots comprises an end effector configured to hold the object and comprising: a first element configured to hold the first or second portion of the object; a second element adapted to be connected to a free end of an arm of the first or second robot; and a passive revolute joint comprising: an outer portion connected to one of the first and second elements; and an inner portion connected to the other one of the first and second elements and being rotatable about a rotation axis relative to the outer portion.

With the above embodiments, the passive revolute joint can provide a passive rotation freedom for the object to rotate relative to the second element of the end effector. This structure enables the object to rotate to align with the target object when the first and second robots move a different distance in the first direction X or move away from each other along the first direction X.

In some embodiments, the rotation axis of the passive revolute joint is perpendicular to a surface of the object. With these embodiments, the passive revolute joint may be arranged onto the end effector in a simple way.

In some embodiments, at least one of the first and second robots comprises an end effector configured to hold the object and comprising a torque sensor, the torque sensor being configured to sense a torque acted on the end effector; and the controller is further configured to cause the first robot or the second robot to move the object such that a measurement value of the torque sensor is within a predetermined range. With these embodiments, when the first and second robots move a different distance in the first direction X or move away from each other along the first direction X, a rotation joint of the end effector will be activated to enable the object to rotate to align with the target object.

In some embodiments, the controller is further configured to cause the first and second robots to move the object in a second direction perpendicular to the first direction. With these embodiments, by moving the object in the second direction, the position of the object may be adjusted more accurately.

In some embodiments, the controller is further configured to cause the first and second robots to move the same distance in the second direction. With these embodiments, the object can be prevented from being bent by the first and second robots.

In some embodiments, the second robot comprises an end effector configured to hold the object and comprising a force sensor configured to sense a force acted on the end effector; and the controller is further configured to cause the second robot to move the object in the second direction such that a measurement value of the force sensor is within a predetermined range. With these embodiments, the object can be prevented from being bent by the first and second robots, and the movements of the first and second robots can be controlled appropriately.

In a second aspect, there is provided an assembling method. The assembling method comprises: causing a first robot arranged near to an assembling station to hold a first portion of an object to be assembled onto a target object arranged on the assembling station; causing a second robot arranged near to the assembling station to hold a second portion of the object spaced apart from the first portion; causing an image sensor arranged above the assembling station to capture images of the object and a target object; based on the captured images, causing the first robot to move the first portion by a first distance in a first direction, and based on the captured images, causing the second robot to move the second portion by a second distance different from the first distance in the first direction or to move the second portion in a direction opposite to the first direction, such that the object is aligned with the target object.

With the above embodiments, the object, especially the object of large size, can be assembled by the cooperation of the robots without increasing accuracy requirement of the individual robot. Moreover, the assembling accuracy can be increased by the cooperation of the robots without need of a very complicated adjusting/feedback system.

In some embodiments, at least one of the first and second robots comprises an end effector configured to hold the object and comprising: a first element configured to hold the first or second portion of the object; a second element adapted to be connected to a free end of an arm of the first or second robot; and a passive revolute joint comprising: an outer portion connected to one of the first and second elements; and an inner portion connected to the other one of the first and second elements and being rotatable about a rotation axis relative to the outer portion.

In some embodiments, the rotation axis of the passive revolute joint is perpendicular to surface of the object.

In some embodiments, at least one of the first and second robots comprises an end effector configured to hold the object and comprising a torque sensor, the torque sensor being configured to sense a torque acted on the end effector; and the method further comprises: causing the first robot or the second robot to move the object such that a measurement value of the torque sensor is within a predetermined range.

In some embodiments, further comprising: causing the first and second robots to move the object in a second direction perpendicular to the first direction.

In some embodiments, causing the first and second robots to move the object in the second direction comprises: causing the first and second robots to move the same distance in the second direction.

In some embodiments, the second robot comprises an end effector configured to hold the object and comprising a force sensor configured to sense a force acted on the end effector; and the method further comprises: causing the second robot to move the object in the second direction such that a measurement value of the force sensor is within a predetermined range.

In a third aspect, there is provided a computer readable storage medium having instructions stored thereon. The instructions, when executed by at least one processor, cause the at least one processor to perform the assembling method according to the second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a conventional assembling apparatus;

FIG. 2 illustrates an assembling apparatus according to some example embodiments of the present disclosure;

FIG. 3 illustrates a partial schematic view of the assembling apparatus as shown in FIG. 2, in which a top view of the object and the target object is shown;

FIG. 4 illustrates a principle for assembling an object onto a target object by means of the assembling apparatus according to some example embodiments of the present disclosure;

FIG. 5 illustrates an assembling apparatus according to some example embodiments of the present disclosure in which the first and second robots are shown partially;

FIG. 6 illustrates an example computing process for controlling the movements of the first and second robots; and

FIG. 7 is a flow chart of an assembling method according to embodiments of the present disclosure.

Throughout the drawings, the same or similar reference numerals represent the same or similar element.

### DETAILED DESCRIPTION

The principle of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise stated, all technical and scientific terms used herein have the same meaning as commonly understood by one of ordinary skill in the art to which this disclosure belongs.

References in the present disclosure to “one embodiment,” “some example embodiments,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some example embodiments, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

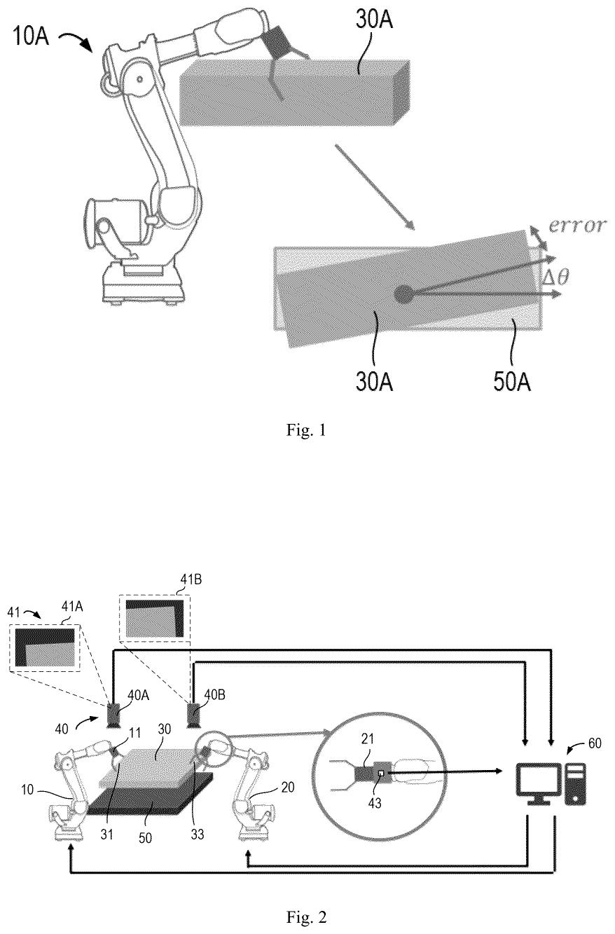

Robots are often used to implement assembling tasks in production line. Conventionally, as shown in FIG. 1 which illustrates a conventional assembling apparatus, one robot 10A is used to assemble an object 30A onto a target object 50A. In order to assemble the object 30A onto the target object 50A, four corners of the object 30A should be aligned with the corresponding corners of the target object 50A. In case that the object 30A is of a large size, such as having a rectangle shape with a long side, the rotation error of the robot 10A would be significantly enlarged by the length of the long side, leading to a bigger error between the corners of the object 30A and the target object 50A. This will decrease the efficiency and accuracy of the assembling process.

According to embodiments of the present disclosure, there is provided an improved assembling apparatus and assembling method. FIG. 2 illustrates an assembling apparatus according to some example embodiments of the present disclosure. As shown in FIG. 2, the assembling apparatus comprises an image sensor 40, a first robot 10, a second robot 20 and a controller 60. The image sensor 40 is arranged above an assembling station (not shown). The first and second robots 10, 20 are arranged near to the assembling station.

The target object 50 is placed on the assembling station. When the object 30 is to be assembled onto the target object 50, the image sensor 40 can capture images of the object 30 and the target object 50.

In some embodiments, as shown in FIG. 2, the image sensor 40 includes two cameras 40A, 40B arranged for capturing images respectively. Each of the cameras 40A, 40B may be arranged to capture different images to obtain information about the position relationship between the object 30 and the target object 50. As shown in FIG. 2, the cameras 40A, 40B are respectively arranged to capture different images 41A, 41B each containing one corner of the object 30 and the corresponding corner of the target object 50. In other embodiments, the image sensor 40 may include more or less cameras. The scope of the present disclosure is not intended to be limited in this respect.

Moreover, it should be understood that embodiments of the present disclosure do not intend to limit the type of the image sensor, and any suitable type of the image sensor is applicable.

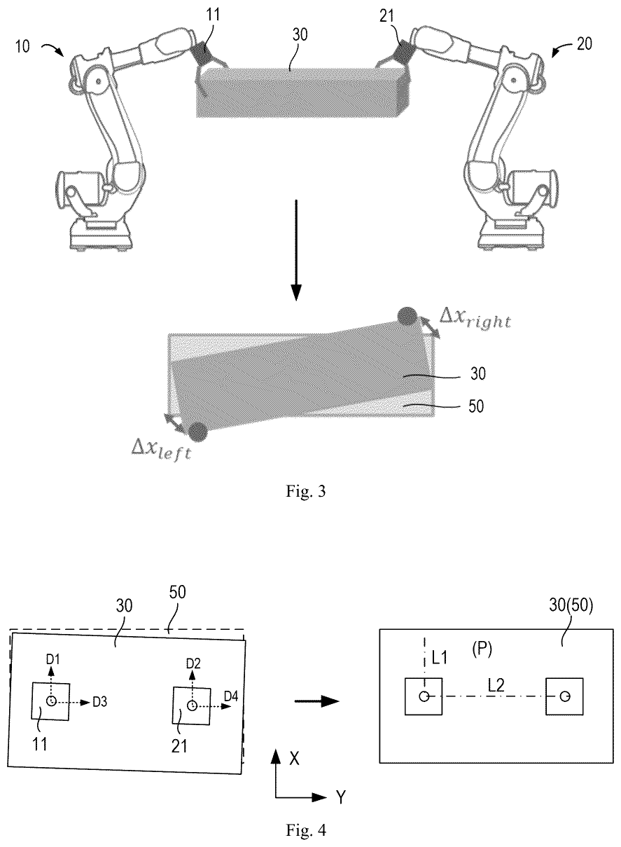

The first robot 10 is configured to hold a first portion 31 of the object 30 and the second robot 20 is configured to hold a second portion 33 of the object 30 spaced apart from the first portion 31. As such, the object 30 could be held by the first and second robots 10, 20. FIG. 3 illustrates a partial schematic view of the assembling apparatus as shown in FIG. 2, in which a top view of the object 30 and the target object 50 is also shown. By moving the first and second robots 10, 20, the accuracy of aligning the object 30 to the target object 50 may be increased, i.e., the errors of Δx_{left} and Δx_{right} may be decreased. Δx_{left} represents the error between one corner of the object 30 and the corresponding corner of the target object 50, and Δx_{right} represents the error between another one corner of the object 30 and the corresponding corner of the target object 50.

In some embodiments, as shown in FIGS. 2 and 3, the first and second robots 10, 20 are articulated robots. However, it is to be understood that the first and second robots 10, 20 can be of suitable types other than the examples as described above. The present disclosure does not intend to limit the types of the first and second robots 10, 20.

By means of the assembling apparatus according to embodiments of the present disclosure, two robots are used to assemble the object 30 onto the target 50, whereby the accuracy requirement of the individual robot can be reduced.

In some embodiments, as shown in FIGS. 2-3, the first and second robots 10, 20 may comprise end effectors 11, 21. The end effectors 11, 21 are configured to hold the object 30. In an embodiment, each of the end effectors 11, 21 may be a clamping jaw having two or more fingers for grasping the object 30. Alternatively, in another embodiment, each of the end effectors 11, 21 may be an adhesive component, such as a vacuum chuck or an electromagnet.

It is to be understood that the end effectors 11, 21 can be of suitable types other than the examples as described above. The present disclosure does not intend to limit the types of the end effectors 11, 21.

The controller 60 of the assembling apparatus may be implemented by any dedicated or general-purpose processor, controller, circuitry, or the like. In some embodiments, the controller 60 may be the controller for the first and second robots 10, 20 as well.

The controller 60 is configured to control the movements of the first and second robots 10, 20. Embodiments of the present disclosure are based on the following insights. In operation, the first and second robots 10, 20 can adjust the orientation of the object 30 to align the object 30 with the target object 50. If the first and second robots 10, 20 move a different distance in the same direction or move in opposite directions, the object 30 may be rotated and then aligned with the target 50 accurately without need of a robot having high rotation accuracy.

It is to be understood that the first and second robots 10, 20 may move the object 30 along any direction other than the examples as described above. The present disclosure does not intend to limit the movement directions of the first and second robots 10, 20. Hereinafter, example movement directions of the first and second robots 10, 20 will be described in detail with reference to FIG. 4.

FIG. 4 illustrates a principle for assembling the object 30 onto the target object 50 by means of the assembling apparatus according to some example embodiments of the present 30 disclosure. Referring to FIGS. 2-4, during assembling, the controller 60 causes the image sensor 40 to capture images 41A, 41B of the object 30 and the target object 50. Then, based on the captured images 41A, 41B, the controller 60 causes the first robot 10 to move the first portion 31 by a first distance D1 in a first direction X, and causes the second robot 20 to move the second portion 33 by a second distance D2 in the first direction X. The second distance D2 is different from the first distance D1, whereby the object 30 may be rotated to align with the target object 50.

Alternatively, in some embodiments, based on the captured images 41A, 41B, the

controller 60 causes the second robot 20 to move the second portion 33 in a direction opposite to the first direction X. As such, the object 30 may be rotated to align with the target object 50.

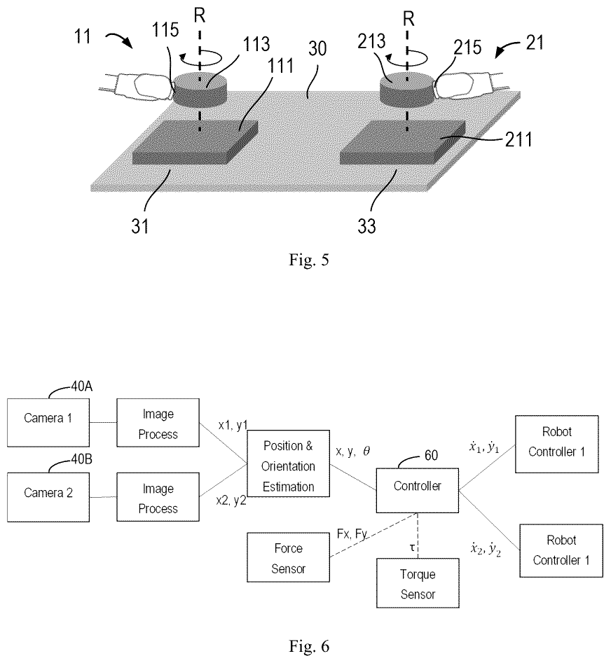

FIG. 5 illustrates an assembling apparatus according to some example embodiments of the present disclosure in which the first and second robots 10, 20 are shown partially. In some embodiments, as shown in FIG. 5, each of the end effectors 11, 21 may comprise a first element 111, 211, a second element 115, 215 and a passive revolute joint 113, 213. The first element 111, 211 is configured to hold the first or second portion 31, 33 of the object 30. The second element 115, 215 is adapted to be connected to a free end of an arm of the first or second robot 10, 20.

When the first and second robots 10, 20 move a different distance (D1/D2) in the first direction X or move in opposite directions, the passive revolute joint 113, 213 is used to enable the object 30 to rotate relative to the end effector 11, 21 such that the object 30 may be aligned with the target object 50. In this way, the structure of the end effector 11, 21 may be simplified in case that the object 30 is moved by the first and second robots 10, 20.

In some embodiments, the passive revolute joint 113, 213 comprises an outer portion and an inner portion which is rotatable about a rotation axis R relative to the outer portion. The outer portion is configured to be connected to one of the first element 111, 211 and the second element 115, 215. The inner portion is configured to be connected to the other one of the first element 111, 211 and the second element 115, 215.

In this way, when the first and second robots 10, 20 move different distances (D1/D2) in the first direction X or move in opposite directions, the passive revolute joint 113, 213 can provide a passive rotation freedom for the object 30 to rotate relative to the end effector 11, 21.

In some embodiments, in case that the object 30 is a plate, the rotation axis R of the passive revolute joint 113, 213 may be perpendicular to a surface of the object 30.

Alternatively or in addition, each of the end effectors 11, 21 may comprise a torque sensor (not shown) which is configured to sense a torque acted on the end effector 11, 21. In this situation, the torque τ sensed by the torque sensor may be transmitted to the controller 60 to determine the movements of the first and second robots 10, 20, as shown in FIG. 6. Thus, the controller 60 may be further configured to cause the first robot 10 or the second robot 20 to move the object 30 such that a measurement value of the torque sensor is within a first predetermined range. The first predetermined range may be pre-stored in any suitable storage or memory accessible by the controller 60.

For example, when the measurement value of the torque sensor is beyond the first predetermined range, the controller 60 may rotate the rotation joint of the end effectors 11, 21 to reduce the torque acted on the end effectors 11, 21. This can avoid a distortion of the object 30 caused by the torque generated by the different patterns (i.e., the first and second distance D1, D2) of the first and second robots 10, 20.

In some embodiments, the controller 60 is further configured to cause the first and second robots 10, 20 to move the object 30 in the second direction Y which is perpendicular to the first direction X. This is beneficial to adjust the position and orientation of the object 30. By moving the object 30 in the second direction Y, the position of the object 30 may be adjusted more accurately.

In some embodiment, the controller 60 is configured to cause the first and second robots 10, 20 to move the same distance in the second direction Y. In this way, the object 30 can be prevented from being bent by the first and second robots 10, 20.

Alternatively or in addition, as shown in FIG. 2, each of the end effectors 11, 21 may comprise a force sensor 43 which is configured to sense a force acted on the end effectors 11, 21. The force Fx, Fy sensed by the force sensor 43 may be transmitted to the controller 60 to determine the movements of the first and second robots 10, 20, as shown in FIG. 6.

The controller 60 may be further configured to cause the second robot 20 to move the object 30 in the second direction Y such that a measurement value of the force sensor 43 is within a second predetermined range. The second predetermined range may be pre-stored in any suitable storage or memory accessible by the controller 60.

For example, when the measurement value of the force Fy is beyond the second predetermined range, the controller 60 may increase the movement distance of the second robot 20 along the second direction Y to reduce the force Fy acted on the end effector 21. In this way, the object 30 can be prevented from being bent by the first and second robots 10, 20.

In other words, the first robot 10 moves in the second direction Y as a master robot, and the second robot 20 moves in the second direction Y as a slave robot. This can prevent the object 30 from being bent or distorted by the asynchronous movement of the first and second robots 10, 20.

Alternatively, the movement of the second robot 20 in the second direction Y can be achieved by a mechanical unit with a passive prismatic freedom. Of course, the first robot 10 may comprise a mechanical unit with a passive prismatic freedom as well.

It should be understood that the present disclosure does not intend to limit the computing process of the controller 60. Any suitable computing process for performing the controlling of the first and second robots 10, 20 may be available.

For example, based on the captured images 41A, 41B, the controller 60 may determine the current position and orientation of the object 30 relative to the target object 50. In order to align the object 30 with the target object 50, the position and orientation of the object 30 should be adjusted based on a target position and orientation for the object 30. Therefore, the first distance D1 is determined to adjust the position of the object 30 and the second distance D2, which is different from the first distance D1, is determined to adjust the orientation of the object 30. Alternatively, the controller 60 may cause the second robot 20 to move in a direction opposite to the first direction X to adjust the orientation of the object 30.

In this way, the first and second robots 10, 20 may adjust the position and orientation of the object 30 relative to the target object 50, such that the object 30 can be aligned with the targeted object 50.

FIG. 6 illustrates an example computing process for controlling the movements of the first and second robots. Taking the embodiments of the image sensor 40 having two cameras 40A, 40B as an example, the controller 60 may first cause the two cameras 40A, 40B to capture images of the object 30 and the target object 50. Image processing technique then may be used to obtain a coordinate (x1, y1) of a first corner of the object 30 and a coordinate (x2, y2) of the second corner of the object 30, and the coordinates of the corresponding corners of the target object 50 may be obtained simultaneously. Based on the obtained coordinates of the object 30 and the target object 50, the controller 60 may estimate the position and orientation (x, y, θ) of the object 30 relative to the target object 50. For example, the position and orientation (x, y, θ) of the object 30 may be determined by:

$$\begin{matrix}x = \frac{{x}_{1} + {x}_{2}}{2} & ( 1 ) \\ y = \frac{{y}_{1} - {y}_{2}}{2} & ( 2 ) \\ θ = \frac{{x}_{1} - {x}_{2}}{L} & ( 3 )\end{matrix}$$

L is a length of the object 30 in a direction from the first portion 31 towards the

second portion 33.

Based on the calculated coordinates (x, y, θ) of the object 30, the controller 60 may determine the respective velocity for the first and second robots 10, 20, i.e., (\dot{x}₁, \dot{y}₁); (\dot{x}₂, \dot{y}₂); For example, the respective velocity of the first and second robots 10, 20 may be determined by:

$$\begin{matrix}{\dot{x}}_{1} = {K}_{x} x + {K}_{θ} θ \frac{L}{2} & ( 4 ) \\ {\dot{x}}_{2} = {K}_{x} x - {K}_{θ} θ \frac{L}{2} & ( 5 ) \\ {\dot{y}}_{1} = {K}_{y} y + {K}_{F} {F}_{y} & ( 6 ) \\ {\dot{y}}_{2} = {K}_{y} y - {K}_{F} {F}_{y} & ( 7 )\end{matrix}$$

\dot{x}₁, \dot{x}₂ represent the velocity for the first and second robots 10, 20 in the first direction X, respectively. \dot{\dot{y}}₁, \dot{y}₂ represent the velocity for the first and second robots 10, 20 in the second direction Y perpendicular to the first direction X, respectively. Kₓ, K_{y}, K_{θ}, or K_{F} is the feedback gain of the controller 60. Fx, Fy respectively represent the forces acting on the end effectors 11, 21 along the first and second direction X, Y.

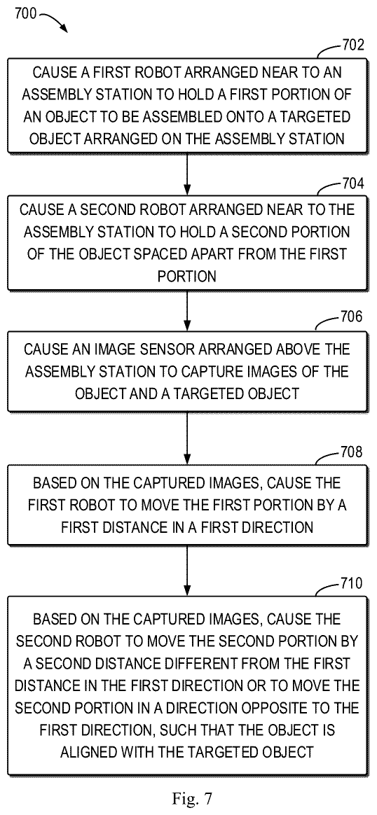

According to embodiments of the present disclosure, an assembling method is also provided. FIG. 7 is a flow chart of an assembling method according to embodiments of the present disclosure. The method 700 can be carried out by, for example the assembling apparatus as illustrated in FIGS. 2-6.

The method comprises, at block 702, causing a first robot 10 arranged near to an assembling station to hold a first portion 31 of an object 30 to be assembled onto a targeted object 50 arranged on the assembling station.

The method comprises, at block 704, causing a second robot 20 arranged near to the assembling station to hold a second portion 33 of the object 30 spaced apart from the first portion 31.

The method comprises, at block 706, causing an image sensor 40A, 40B arranged above the assembling station to capture images 41 of the object 30 and a targeted object 50.

The method comprises, at block 708, based on the captured images 41, causing the first robot 10 to move the first portion 31 by a first distance D1 in a first direction X.

The method comprises, at block 710, based on the captured images 41, causing the second robot 20 to move the second portion 33 by a second distance D2 different from the first distance D1 in the first direction X or to move the second portion 33 in a direction opposite to the first direction X, such that the object 30 is aligned with the targeted object 50.

In some embodiments, at least one of the first and second robots 10, 20 comprises an end effector 11, 21 configured to hold the object 30. The end effector 11, 21 comprises: a first element 111, 211 configured to hold the first or second portion 31, 33 of the object 30; a second element 115, 215 adapted to be connected to a free end of an arm of the first or second robot 10, 20; and a passive revolute joint 113, 213. The passive revolute joint 113, 213 comprises: an outer portion connected to one of the first and second elements 111, 211; 115, 215; and an inner portion connected to the other one of the first element 111, 211 and second element 115, 215. The inner portion is rotatable about a rotation axis R relative to the outer portion. In some embodiments, the rotation axis R of the passive revolute joint 113, 213 is perpendicular to surface of the object 30.

In some embodiments, at least one of the first and second robots 10, 20 comprises an end effector 11, 21 configured to hold the object 30. The end effector 11, 21 comprises a torque sensor, and the torque sensor is configured to sense a torque acted on the end effector 11, 21. The method 700 may further comprise: causing the first robot 10 or the second robot 20 to move the object 30 such that a measurement value of the torque sensor is within a predetermined range.

In some embodiments, the method 700 further comprises: causing the first and second robots 10, 20 to move the object 30 in a second direction Y perpendicular to the first direction X. In some embodiments, causing the first and second robots 10, 20 to move the object 30 in the second direction Y comprises: causing the first and second robots 10, 20 to move the same distance in the second direction Y.

In some embodiments, the second robot 20 comprises an end effector 21 configured to hold the object 30. The end effector 21 may comprise a force sensor 43 configured to sense a force acted on the end effector 21. The method 700 further comprises: causing the second robot 20 to move the object 30 in the second direction Y such that a measurement value of the force sensor 43 is within a predetermined range.

In some embodiments of the present disclosure, a computer readable medium is provided. The computer readable medium has instructions stored thereon, and the instructions, when executed on at least one processor, may cause at least one processor to perform the method 700 as described in the preceding paragraphs, and details will be omitted hereinafter.

In the context of the subject matter described herein, a memory may be any tangible medium that can contain, or store a program for use by or in connection with an instruction execution system, apparatus, or device. The memory may be a machine readable signal medium or a machine readable storage medium. A memory may include but not limited to an electronic, magnetic, optical, electromagnetic, infrared, or semiconductor system, apparatus, or device, or any suitable combination of the foregoing. More specific examples of the memory would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

1. An assembling apparatus comprising:
an image sensor arranged above an assembling station;
a first robot arranged near to the assembling station and configured to hold a first portion of an object to be assembled onto a target object arranged on the assembling station;
a second robot arranged near to the assembling station and configured to hold a second portion of the object spaced apart from the first portion; and
a controller configured to:
cause the image sensor to capture images of the object and the target object;
based on the captured images, cause the first robot to move the first portion by a first distance in a first direction; and
based on the captured images, cause the second robot to move the second portion by a second distance different from the first distance in the first direction or move the second portion in a direction opposite to the first direction, such that the object is aligned with the target object.

2. The assembling apparatus of claim 1, wherein at least one of the first and second robots comprises an end effector configured to hold the object and comprising:
a first element configured to hold the first or second portion of the object;
a second element adapted to be connected to a free end of an arm of the first or second robot; and
a passive revolute joint comprising:
an outer portion connected to one of the first and second elements; and
an inner portion connected to the other one of the first and second elements and being rotatable about a rotation axis relative to the outer portion.

3. The assembling apparatus of claim 2, wherein the rotation axis of the passive revolute joint is perpendicular to a surface of the object.

4. The assembling apparatus of claim 1, wherein at least one of the first and second robots comprises an end effector configured to hold the object and comprising a torque sensor, the torque sensor being configured to sense a torque acted on the end effector; and
wherein the controller is further configured to cause the first robot or the second robot to move the object such that a measurement value of the torque sensor is within a predetermined range.

5. The assembling apparatus of claim 1, wherein the controller is further configured to cause the first and second robots to move the object in a second direction perpendicular to the first direction.

6. The assembling apparatus of claim 5, wherein the controller is further configured to cause the first and second robots to move the same distance in the second direction.

7. The assembling apparatus of claim 5, wherein the second robot comprises an end effector configured to hold the object and comprising a force sensor configured to sense a force acted on the end effector; and
wherein the controller is further configured to cause the second robot to move the object in the second direction such that a measurement value of the force sensor is within a predetermined range.

8. An assembling method, comprising:
causing a first robot arranged near to an assembling station to hold a first portion of an object to be assembled onto a target object arranged on the assembling station;
causing a second robot arranged near to the assembling station to hold a second portion of the object spaced apart from the first portion;
causing an image sensor arranged above the assembling station to capture images of the object and a target object;
based on the captured images, causing the first robot to move the first portion by a first distance in a first direction, and
based on the captured images, causing the second robot to move the second portion by a second distance different from the first distance in the first direction or to move the second portion in a direction opposite to the first direction, such that the object is aligned with the target object.

9. The assembling method of claim 8, wherein at least one of the first and second robots comprises an end effector configured to hold the object and comprising:
a first element configured to hold the first or second portion of the object;
a second element adapted to be connected to a free end of an arm of the first or second robot; and
a passive revolute joint comprising:
an outer portion connected to one of the first and second elements; and
an inner portion connected to the other one of the first and second and being rotatable about a rotation axis relative to the outer portion.

10. The assembling method of claim 9, wherein the rotation axis of the passive revolute joint is perpendicular to surface of the object.

11. The assembling method of claim 8, wherein at least one of the first and second robots comprises an end effector configured to hold the object and comprising a torque sensor, the torque sensor being configured to sense a torque acted on the end effector; and
wherein the method further comprises:
causing the first robot or the second robot to move the object such that a measurement value of the torque sensor is within a predetermined range.

12. The assembling method of claim 8, further comprising:
causing the first and second robots to move the object in a second direction perpendicular to the first direction.

13. The assembling method of claim 12, wherein causing the first and second robots to move the object in the second direction comprises:
causing the first and second robots to move the same distance in the second direction.

14. The assembling method of claim 12, wherein the second robot comprises an end effector configured to hold the object and comprising a force sensor configured to sense a force acted on the end effector; and
wherein the method further comprises:
causing the second robot to move the object in the second direction such that a measurement value of the force sensor is within a predetermined range.

15. A computer readable storage medium having instructions stored thereon, the instructions, when executed by at least one processor, cause the at least one processor to perform the assembling method according to claim 8.

16. A computer readable storage medium having instructions stored thereon, the instructions, when executed by at least one processor, cause the at least one processor to perform the assembling method according to claim 9.

17. A computer readable storage medium having instructions stored thereon, the instructions, when executed by at least one processor, cause the at least one processor to perform the assembling method according to claim 10.

18. A computer readable storage medium having instructions stored thereon, the instructions, when executed by at least one processor, cause the at least one processor to perform the assembling method according to claim 11.

19. A computer readable storage medium having instructions stored thereon, the instructions, when executed by at least one processor, cause the at least one processor to perform the assembling method according to claim 12.

20. A computer readable storage medium having instructions stored thereon, the instructions, when executed by at least one processor, cause the at least one processor to perform the assembling method according to claim 13.
